(19) United States
(12) Patent Application Publication
(10) Pub. No.: US 2006/0011598 A1
(43) Pub. Date: Jan. 19, 2006

(54) Vehicular lamp

(75) Inventor: Yuji Yasuda, Shizuoka (JP)

Correspondence Address: KODA & ANDROLIA, 2029 CENTURY PARK EAST, SUITE 1140, LOS ANGELES, CA, 90067, US

(73) Assignee: Koito Manufacturing Co., Ltd.

(21) Appl. No.: 11/181,499

(22) Filed: Jul. 14, 2005

(30) Foreign Application Priority Data
Jul. 16, 2004 (JP) P. 2004-209750

(51) Int. Cl. B60L 1/02

(52) U.S. Cl. 219/205

(57) ABSTRACT

A vehicular lamp with an outer lens made of resin, the outer lens having a built-in heater which is formed by a copper wire or a tungsten wire of 20 to 80 μm diameter.

### BACKGROUND OF THE INVENTION

1. Technical Field

The present invention relates to a vehicular lamp and more particularly to a vehicular lamp having a heater in integral with the outer (covering) lens for the purpose of, for instance, melting snow and defogging.

2. Description of the Related Art

In some vehicular lamps, a heater is provided integral with the outer lens for the purpose of, for instance, melting snow on the lens and defogging the lens.

In one method for integrating a heater in a vehicular lens, a conductive heating element is formed by disposing low-resistance metallic foils with gap in between on the inner surface of the lens to form two electrodes and by coating conductive pastes in parallel between the electrodes, and electric current is caused to flow via the electrodes in the conductive heating element formed from the conductive paste, thus generating heat.

In another method, a nichrome wire is used. The nichrome wire is connected in parallel to two electrodes made of low-resistance metallic foil similar to the above method, and heat is generated by allowing electric current to flow in the nichrome wire via the electrodes.

In yet another method, an indium tin oxide (ITO) film is formed on the inner surface of the lens, and electrodes formed from low-resistance metallic foil is separately connected to both edges of the ITO film, thus allowing the electric current to flow in the ITO film via the electrodes, thus generating heat.

Of the above-described methods, in the method that forms a conductive heating element using conductive paste, the coating width of the conductive paste cannot be 0.5 mm or below. As a result, a large amount of light is blocked by the conductive paste, deteriorating light distribution.

In the method that uses the ITO film, since the ITO film's light distribution is low, the light transmittance is deteriorated.

In the method that uses nichrome wires, the light distribution is not affected as much as that of the above two methods. However, since the nichrome wires has a high resistance value, a required heat amount is not obtained by the voltage of a battery mounted in a vehicle. As a result, an additional device such as a booster circuit or the like is required, and it causes the lamp to be costly. In addition, since the nichrom wires have high resistance, small wire diameter nichrom wires cannot be used, and it is impossible to employ long circuitry. As a result, parallel circuits made from short wires are necessary to cover the required areas.

Furthermore, all of the above-described methods require that electrodes be provided at two separate locations. It is, therefore, necessary to supply electric current to two locations, and this makes the current supply structure complicated.

### BRIEF SUMMARY OF THE INVENTION

In view of the above, it is an object of the present invention to provide a vehicular lamp that generates a sufficient heat amount with the use of the in-vehicle battery and is less influential to the light distribution.

The above object is accomplished by a unique structure of the present invention for a vehicular lamp that has an outer lens provided with a built-in heater, and the heater is formed by wiring a copper wire or a tungsten wire that has a wire diameter of 20 to 80 μm.

In this structure of the vehicular lamp of the present invention, a sufficient heat amount is obtained by the voltage of the car battery, and thus the heater (the copper or tungsten wire) has almost no affect to the light distribution.

As seen from the above, in the vehicular lamp of the present invention, the outer lens is made of resin, the outer lens has a built-in heater, and the heater is formed by wiring a copper wire or a tungsten wire that is 20 to 80 μm in diameter.

As described above, in the vehicular lamp of the present invention, copper wires or tungsten wires that have lower resistance value than nichrome wires are used for the heater. As a result, a heat amount needed for melting snow and the like can be achieved using the voltage of the battery, and a special booster circuit or the like is not required. Since the diameter of the copper and tungsten wires is 80 μm or less, the heater does not affect the light distribution even when they are used in a headlamp for vehicles, and a reduction in the maximum light intensity can be limited to 0.5% or less. In addition, the presence of the wire is difficult to perceive when the outer lens is viewed with the light of the lamp unlit, and thus the wires do not deteriorate the outer appearance of the vehicular lamp. Moreover, the copper and tungsten wires used in the present invention are 20 μm or larger in diameter, and thus there is no risk of coil breakage.

In the present invention, since the copper wire and the tungsten wire can be provided in at least a portion of the heater at intervals of 5 to 20 mm, sufficient heat is transmitted to the lens without lowering the amount of light emitted.

Furthermore, in the present invention, copper wires and tungsten wires that are coated for insulation purposes can be employed. When the insulation coated wires are used, the circuit layout for the heater can be configured so that the heat coils are installed to cross over, and it is thus possible to easily integrate heat coils at a power supply (power feeding) portion. It is further possible to draw a model name or number of the vehicle and the manufacturer's name of the vehicle and other desired patterns with the heat coil.

### BRIEF DESCRIPTION OF THE DRAWINGS

FIG. 1 is a schematic front view of the vehicular headlamp according to the present invention; and

FIG. 2 is a sectional view taken along the line II-II in FIG. 1.

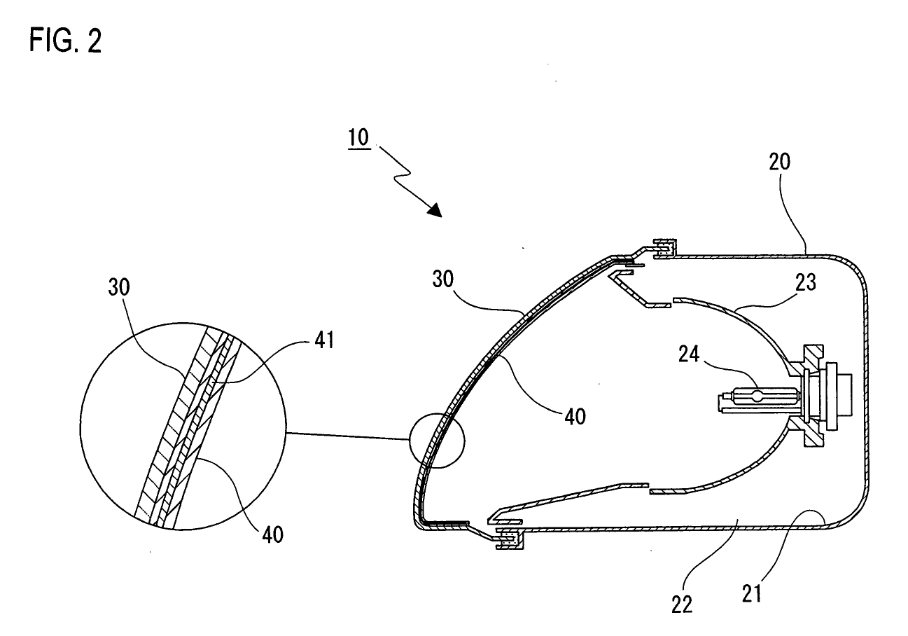

### DETAILED DESCRIPTION OF THE INVENTION

Hereinafter, the best mode for carrying out the present invention will be described with reference to the accompanying drawings. The description will be made on a vehicular lamp, particularly a vehicular headlamp.

The vehicular headlamp 10 is comprised of a lamp body 20 having a concave portion 21 that opens forward, and the front opening of the lamp body 20 is covered by an outer lens 30. A light source 24 is attached to the reflector 23 that is tiltably provided using a reflector supporting mechanism (not shown) in the lamp chamber 22 which is defined by the lamp body 20 and the outer lens 30. For the light source 24, a cold light source, such as a metal halide (HID) lamp, a light-emitting diode (LED) or the like, is used; and an incandescent bulb, such as a halogen bulb or the like, can be used as well.

The outer lens 30 is formed from a transparent synthetic resin, such as acrylic resin, polycarbonate (PC) or the like, and the inner surface of the outer lens 30 is formed with a built-in heater 40.

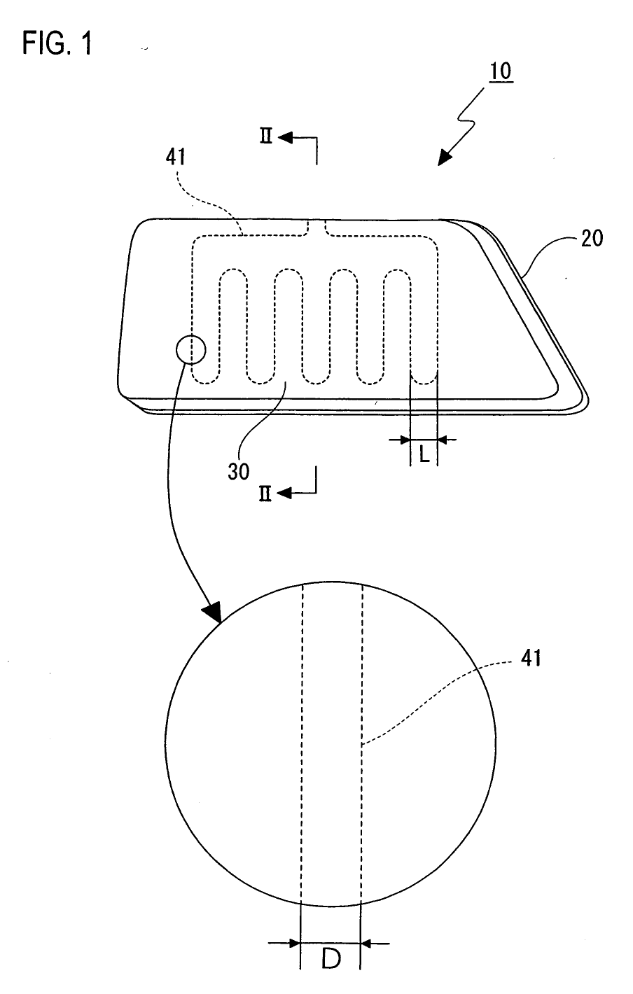

The heater 40 is formed by wiring a copper wire or a tungsten wire (hereinafter called a “resistance heat coil”) 41 that has a wire diameter D of 20 to 80 μm. The resistance heat coil 41 is disposed in, for example, a pattern as shown in FIG. 1. More specifically, the resistance heat coil 41 is provided in a rectangle area of the size that covers the substantial part of the front portion of the outer lens 30, and the resistance heat coil 41 extend in an up-down direction and is arranged in parallel at regular intervals, so that the resistance heat coil 41 is in a zigzag pattern by the single resistance heat coil 41. Both ends of the resistance heat coil 41 are positioned at one edge (at the upper edge in the structure shown in FIG. 1) of the outer lens 30. The space L which is between the adjacent parallel portions of the resistance heat coil 41 is set to be 5 mm to 20 mm.

As described above, the diameter D of the resistance heat coil 41 is preferably in the range of 20 μm to 80 μm. If the diameter of the resistance heat coil 41 exceeds 80 μm, a large amount of light from the light source 24 is blocked by the resistance heat coil 41, and the light distribution is deteriorated. A resistance heat coil with a wire diameter of 80 μm or less would limit the reduction of the maximum light intensity to 0.5% or less; and in addition, such a coil is difficult to perceive when the outer lens is viewed with the lamp unlit, and it does not deteriorate the outer appearance of the vehicular headlamp. On the other hand, a resistance heat coil that is less than 20 μm in diameter has a risk of breakage.

Furthermore, if the space L between the adjacent resistance heat coils 41 is less than 5 mm, then a large amount of light from the light source 24 is blocked by the resistance heat coil 41, and the light distribution is deteriorated. On the other hand, if the space L between adjacent resistance heat coils 41 is greater than 20 mm, then the amount of heat generated by the resistance heat coil 41 would not be sufficient for the surface area of the outer lens 30, and a snow-melting function would not be fully exercised.

For installing the heater 40 on the inner surface of the outer lens 30, various means can be employed. In one method, an adhesive layer created by, for example, heat curing type adhesives, ultraviolet curing type adhesives or the like is formed on the inner surface of the outer lens 30, a copper wire or a tungsten wire is provided on the adhesive layer, and then the adhesive layer is hardened by heat or ultraviolet irradiation.

Another method for installing the heater 40 uses an insert molding. In this method, the heater 40 is formed separate from the outer lens 30 in advance, the heater 40 is set in a mold cavity that is used to form the outer lens 30, the resin material for the outer lens 30 is injected into the cavity, and the outer lens 30 is molded with the heater 40 integrated therewith.

As described above, the heater 40 embedded in the outer lens 30 of the vehicular headlamp 10 is formed by wiring the heat coil (a copper wire or a tungsten wire) 41 that has a diameter of 20 to 80 μm. Therefore, a sufficient heat amount can be obtained using the voltage of a car battery normally used in vehicles, and a special booster circuit or the like is not required. In addition since the resistance value of the copper wire and tungsten wire is low compared to the nichrome wire that is used in the past, a method to connect in parallel the multiple resistance heat coils that are cut into short size is no longer necessary; and instead a wiring layout in which a single continuous wire is used as a connected heat coil is accomplished. Consequently, a power supply for the heater can be installed in one location, and this simplifies the power feed line to the heater 40. Moreover, a high degree of freedom in the wiring layout can be secured, and it is possible to accomplish an efficient power consumption by such an arrangement that a higher wiring density is provided at locations where a large amount of snow is expected to accumulate and a lower wiring density is provided at locations where only a small amount of snow is expected to accumulate.

In addition, the resistance heat coils 41, namely the copper wire or the tungsten wire, can be covered by an insulated coating, and this makes a circuit layout in which the heat coils are provided to cross over possible, and it also makes it possible to integrate the heat coils at a power supply portion. It is further possible to draw a symbol characteristic of a model name of the vehicle and/or a manufacturer's name and any other desired patterns, etc. with the heat coil.

It should be noted that though in the embodiment above an example in which the present invention is applied to a vehicular headlamp is described, this does not limit the application range of the present invention, and naturally the present invention is applicable to other vehicular lamps as well.

Furthermore, the shape and structure of each element and portion of the above embodiment are all mere indication of one example of carrying out the present invention, and the technical scope of the present invention must not be interpreted as limited in any manner by such an example.

The present invention is applicable to a vehicular lamp used in a cold region and provides a vehicular lamp that has a high snow-melting effect at low cost.

1. A vehicular lamp having an outer lens made of resin, wherein the outer lens is provided with a heater which is formed by one of a copper wire and a tungsten wire having a diameter of 20 to 80 μm.

2. The vehicular lamp according to claim 1, wherein one of the copper wire and the tungsten wire is arranged in at least a portion of the heater at intervals of 5 to 20 mm.

3. The vehicular lamp according to claim 1, wherein one of the copper wire and the tungsten wire has an insulated coating thereon.

4. The vehicular lamp according to claim 2, wherein one of the copper wire and the tungsten wire has an insulated coating thereon.
